(19) United States
(12) Patent Application Publication
(10) Pub. No.: US 2008/0152165 A1
(43) Pub. Date: Jun. 26, 2008

(54) Ad-hoc proximity multi-speaker entertainment

(76) Inventor: Luca Zacchi, Varzo (Verbania) (IT)

Correspondence Address: LUMEN PATENT FIRM, INC., 2345 YALE STREET, SECOND FLOOR, PALO ALTO, CA, 94306, US

(21) Appl. No.: 12/005,998

(22) Filed: Jan. 18, 2008

Related U.S. Application Data
(60) Provisional application No. 60/881,725, filed on Jan. 19, 2007.

(30) Foreign Application Priority Data
Jul. 1, 2005 (IT) MN2005A000042
Jun. 29, 2006 (IT) MN2006A000042

(51) Int. Cl. H04B 3/00

(52) U.S. Cl. 381/77

(57) ABSTRACT

A new form of musical entertainment is provided by creating an audio show from a plurality of independently-generated audio data sets. Each of the independently-generated audio data sets contains a plurality of distinct audio parts prepared to play as part of an audio show in a synchronized manner. A group of people each having a personalized audio device is brought together at hearable distance from each other. On each device, a playback audio part is selected from the same audio data set. Comparing all selected audio parts in the group there will be at least two selected playback audio parts that are different from each other. All personalized audio devices in the group can be synchronized to a synchronized playback mode. The selected audio parts can be played back through the loudspeakers of the personalized audio devices thereby creating an audio show among the group.

### CROSS-REFERENCE TO RELATED APPLICATIONS

This application claims priority from U.S. provisional patent application No. 60/881,725 filed Jan. 19, 2007, which is incorporated herein by reference.

### FIELD OF THE INVENTION

The present invention relates generally to methods and systems for generating and playing back music in a synchronized fashion. More particularly, the present invention relates to methods and systems for creating an audio show among users each having a personalized audio system whereby the personalized audio systems function as playback devices and loudspeakers.

### BACKGROUND OF THE INVENTION

As long as people lived they have created music. These creations are the result of inspirations and extensive practice by individual musicians, bands or orchestras. Musical creations could be shared through a live performance or through playback of typically a digital recording on a (portable) device, radio, TV, or the like. Musicians could also gather and play (“jam”) without extensive preparation or predefined arrangements.

Along with the advances of digital technology, a user of a digital software program would be able to change musical and sound compositions of a digital recording. The user may then listen to a song and with the edited changes to the song be able to hear a different version of the song. Another development stemming from the digital age relates to sharing the same digital media between devices and portable devices in particular. For example, a user of a portable device would be able to transmit music from his/her portable device to another portable device. In another example, shared audio listening could be established where peer listeners connected by a wireless ad-hoc network listen to the same song at the same time. However, sharing of music remains restricted to sharing the same song or piece of music.

The present invention advances the art with new and exciting ways for people to enjoy musical entertainment.

### SUMMARY OF THE INVENTION

The present invention provides a method and system for creating an audio show, which can be regarded as a new form of musical entertainment. A group of people each having a personalized audio device is brought together at hearable distance from each other. The personalized audio devices are capable to communicate and synchronize with each other. They are further capable of functioning as a loudspeaker to playback audio. A user interface on each of the devices allows for user input. A plurality of independently-generated audio data sets is available. Each of the independently-generated audio data sets contains a plurality of distinct audio parts prepared to play as part of an audio show in a synchronized manner. On each of the personalized audio devices in the group, the user can select one of the playback audio parts from the same audio data set. Comparing all selected audio parts in the group there will be at least two selected playback audio parts that are different from each other. All personalized audio devices in the group can be synchronized to a synchronized playback mode. Once in synchronized playback mode, the selected audio parts can be played back through the loudspeakers of the respective personalized audio devices, resulting in mixing the playback audio parts according to the determined synchronization and creating an audio show among the group of users with their personalized audio devices.

### BRIEF DESCRIPTION OF THE FIGURES

The present invention together with its objectives and advantages will be understood by reading the following description in conjunction with the drawings, in which:

FIG. 1 shows according to the present invention an example of a group of users each with a personalized audio device playing back at least one composition (i.e. at least one audio part of the same audio data set) through their build-in loudspeakers.

FIG. 2 shows according to the present invention an example of the musical entertainment method and system (for clarity purposes the (remote) storage system and database as discussed in the detailed description are not shown).

FIG. 3 shows according to the present invention an example of an audio data set containing a plurality of audio data parts. Further shown is an example of information (e.g. one or more parameters) for each of the audio parts. The audio data set and the associated data components could be stored on a (remote) storage system and accessible e.g. through a database or web structure by the users of the personalized audio devices, or directly from a storage medium on or attached to the personalized audio devices.

FIG. 4 shows according to the present invention an example of the multi-speaker entertainment based on personalized audio devices, whereby the personalized audio devices are compared to the number of speakers in other systems. For example, the monogram with one speaker, the stereo with two speakers, the surround system with five speakers and the multi-speaker system with twenty personalized audio devices acting as loudspeakers.

### DETAILED DESCRIPTION

The present invention provides a new form of musical entertainment. The key concept is to enable a group of users with personalized audio devices to create an audio show. As it becomes apparent from the description, this audio show will be a unique form of musical entertainment or jam session performed through the personalized audio devices.

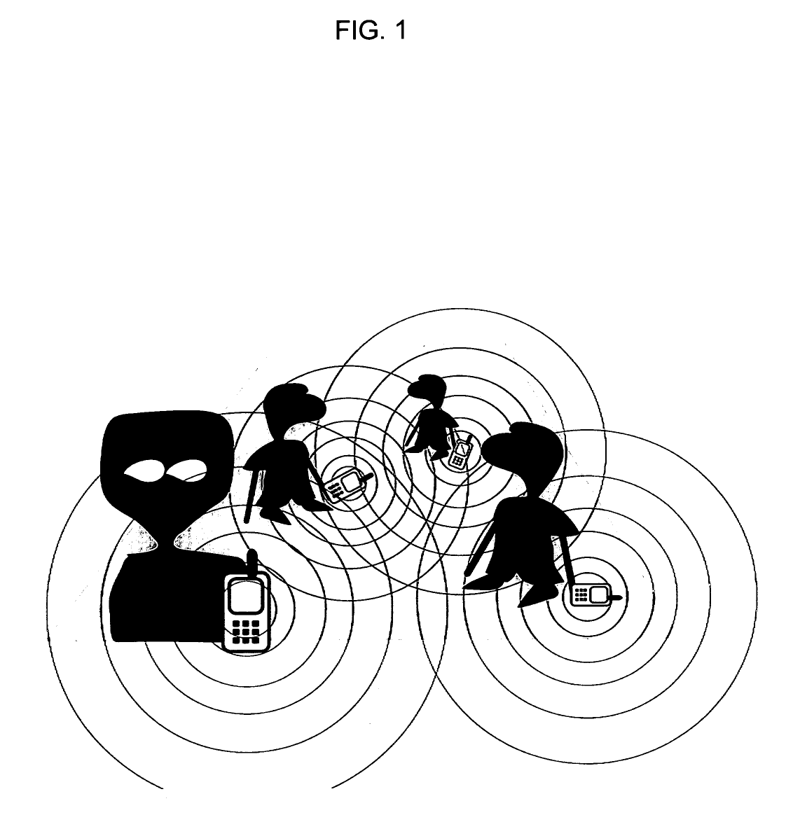

The audio show is created among a group of users that are together preferably at hearable distance from each other (FIG. 1). Each of the users has a personalized audio device which could vary from a mobile phone, smart phone, portable computer, PDA, portable gaming console or a special device developed to support the audio show functionality and software.

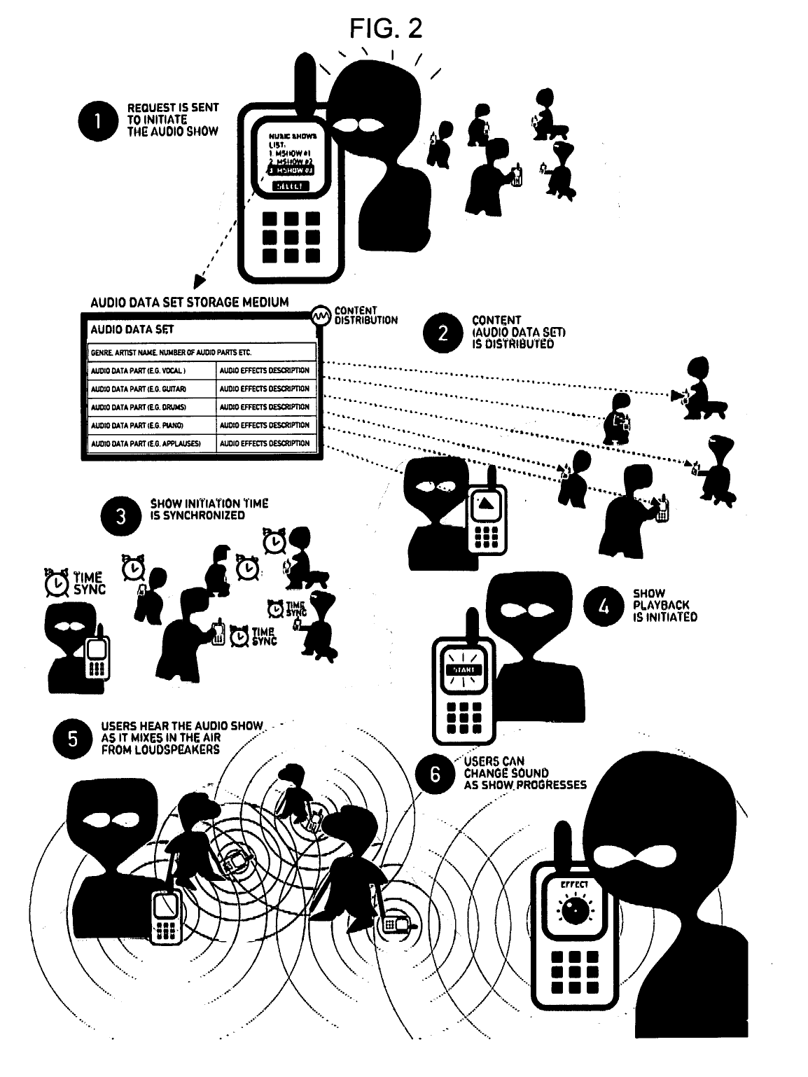

Each of the personalized audio devices is capable of communicating with the other personalized audio systems via a communication system or medium. The personalized audio systems are also able to function as a loudspeaker. A storage medium could be part of the personalized audio system for storing data. A user interface allows users to communicate with the personalized audio device and over the communication system or medium with a (remote) storage system, web accessible portals, database and other personalized audio devices. Each personalized audio device is equipped with a playback synchronization mechanism to (time)-synchronize to the other personalized audio devices when initiation and/or playing the audio show (FIG. 2). A server or the initiating personalized audio device could send time signals (data packets containing time information) to all personalized audio devices in the group and the devices then adjusts their internal clocks to sent time signals. The audio show playback could be triggered at some time that is (pre)-defined. The personalize audio devices continue to receive and adjusts to time signals even when show is in progress.

A group of personalized audio devices can be defined according to the following exemplary options. In the first example, personalized audio devices are automatically joining the group when the devices are in proximity and “see” each other (e.g. by Bluetooth interface). User can make device to join the group by pressing a “join” key. In the second example, one of the personalized audio devices can be designated to be the initiator of the audio show. The initiator-device could show a unique number. This unique number could be used by the other users and entered on their personalized audio devices if they wish to join the group. A server or the initiator-device could identify that all personalized audio devices with the same unique number and define the group. The unique number could be communicated between users verbally or through their personalized audio devices.

A plurality of independently-generated audio data sets is available and could be stored either on one or all of the personalized audio devices in the group or on a (remote) storage system accessible via the communication system/medium by personalized audio devices. In one example, the storage system is accessible through a web portal and database where the users are able to browse, select and download data from. In another example, a user of a personalized audio device could select an audio data set and then distribute the audio data set with its content, i.e. audio data parts and possible other associate information and/or parameters, to the other personalized audio devices in the group. Each personalized audio device could run specialized software clients to enable downloading audio data sets such as Symbian, WinMobile, J2ME, Brew or the like. Examples of network protocols used for a communication system or medium could for example be GPRS/EDGE, 3 G/UMTS, WiFi, WiMax, Bluetooth or the any other type of wired or wireless network protocol.

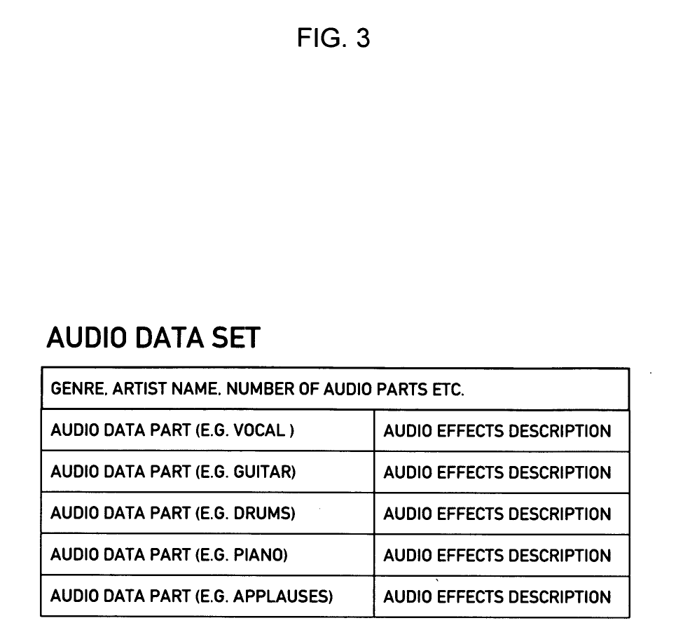

Each of the independently-generated audio data sets has a plurality of distinct audio parts that contains a digital music recoding of distinct music instruments (e.g. piano, violin, drums or the like) or other type of sounds (e.g. vocal, sound effects like blasts, or the like). Each of these audio parts in audio data set is authored to form one show. In other words, it is important that the audio parts are designed to play well together as one concerto or show in a synchronized manner. Each audio data set contains information, such as audio data, characteristics regarding the audio content, genre, artist number of audio parts etc. (FIG. 3). Audio parts could contain music instruments playback, special sound effects (e.g. blasts, claps, noises) in digital format (e.g. MP3, WMA etc.) (audio data).

Each user with a personalized audio device and part of the group can select at least one playback audio part from the same audio data set on their respective personalized audio system that is either stored on their device or accessible via the communication system or medium. It is noted that for a group, the selected audio parts for the specific audio show are from the same audio data set, which enables synchronous playback. In one example, at least two of the selected playback audio parts in the group are different from each other when comparing all selected audio parts within the group. The total number of selected audio parts can vary from a small to a large number resembling an orchestra. In general, there are at least two or more selected audio parts for an audio show, which are distinct from each other.

Each of the personalized audio devices is capable of either playing back the selected audio parts from the storage medium on their personalized audio device or playing back the audio parts from the storage system and over the communication medium.

The synchronization of an audio show is typically accomplished from one of the personalized audio devices in the group, which will (time)-synchronize all participant's devices in the group. Upon synchronization, anyone in the group could initiate the audio show through input on their respective personalized audio device.

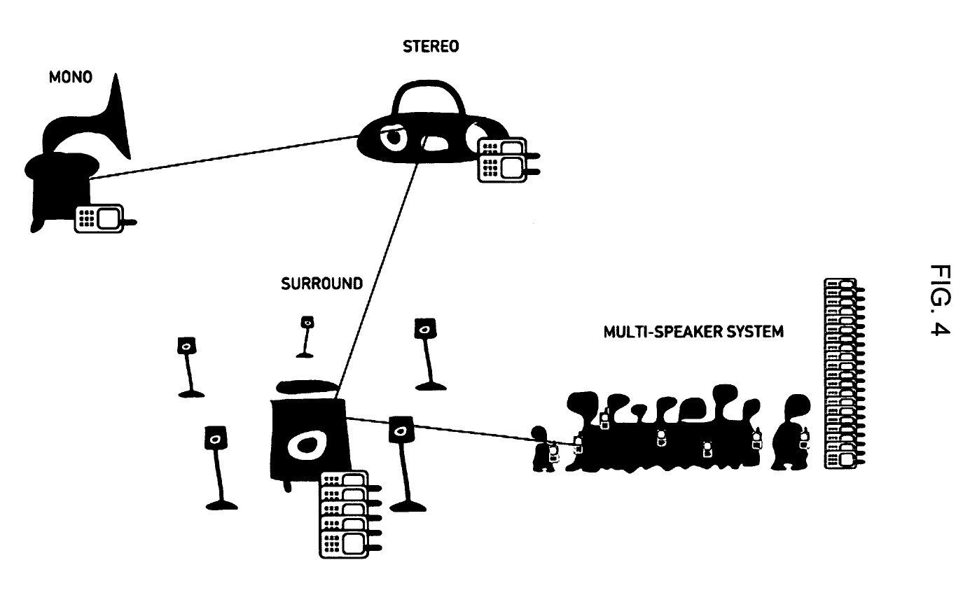

In a synchronized playback mode, the users in the group can now play back through the loudspeaker on their respective personalized audio systems their selected audio part(s). It is noted that the audio parts played-back by a user could be one or more. Accordingly, the playback audio parts from all personalized audio devices in the group are mixed and played back as defined by their synchronization, which creates an audio show among the group of users with their personalized audio devices. It is further noted that the selected audio parts from an audio data set can be any number and any combination of possible audio parts, which will allow users to create unique and different audio shows. The playback could therefore also be viewed as a multi-speaker system playing back multi-channel audio parts whereby the speakers are the personalized audio devices (FIG. 4).

Before or during playback each of the users would be able to control one or more parameters to change the audio output of their playback audio part or they could change one audio part to another from the (same) selected audio data set. Users could for example change instrument, tracks, sounds, volume, effects or the like. If the change of parameters occurs during playback then the software running on the personalized audio devices ensures that the changed audio part remains in synchronized playback mode.

What is claimed is:

1. A method for creating an audio show, comprising:
(a) having a plurality of independently-generated audio data sets, wherein each of said independently-generated audio data sets comprises a plurality of distinct audio parts prepared to play as part of an audio show in a synchronized manner;
(b) having together a group of personalized audio devices at hearable distance from each other for their respective users, wherein each of said personalized audio devices:
(i) is capable of communicating with and synchronizing to the other personalized audio devices in said group via a communication medium,
(ii) is capable of functioning as a loudspeaker,
(iii) is capable of playing back said audio parts,
(iv) has a user-interface for receiving input from it's user, and
(c) on each of said personalized audio devices in said group selecting one of said playback audio parts from the same audio data set, wherein at least two of said selected playback audio parts in said group are different from each other when comparing all selected audio parts within said group;
(d) synchronizing said personalized audio devices in said group to a synchronized playback mode; and
(e) in said synchronized playback mode, playing back through the loudspeakers of the respective personalized audio devices said selected audio parts and thereby mixing said playback audio parts according to the determined synchronization and creating an audio show among the group of users with their personalized audio devices.

2. The method as set forth in claim 1, further comprising having a storage system with a database containing said plurality of independently-generated audio data sets and their respective plurality of audio parts.

3. The method as set forth in claim 2, wherein said storage system is a remote storage system accessible by said group of personalized audio devices via said communication medium.

4. The method as set forth in claim 1, wherein each of said personalized audio devices is capable of communicating with said storage device for selecting or downloading at least one audio part from an audio data set.

5. The method as set forth in claim 1, wherein each of said personalized audio devices is capable of playing back said selected audio part from a storage medium on said personalized audio device or playing back said selected audio part from said storage system and over said communication medium.

6. The method as set forth in claim 1, further comprising initiating said synchronized playback from one of said personalized audio devices thereby initiating said synchronized playback for all personalized audio devices in said group.

7. The method as set forth in claim 1, wherein said synchronizing is time synchronizing.

8. The method as set forth in claim 1, further comprising changing, during playback, one of said selected audio parts to another audio part from the same audio data set while remaining in synchronized playback mode.

9. The method as set forth in claim 1, wherein each of said audio parts include an information data set pertaining to said audio part.

10. The method as set forth in claim 1, further comprising controlling one or more parameters on one or more of said personalized audio devices to change the audio output of said respective playback audio part.

11. The method as set forth in claim 10, wherein said controlling occurs during said synchronized playback and wherein the playback of said changed audio part remains in said synchronized playback mode.

12. The method as set forth in claim 1, further comprising having one of said personalized audio devices selecting an audio data set and distributing said selected audio data set with its audio data parts to the other personalized audio device within said group.

13. The method as set forth in claim 1, wherein said group is defined by having said personalized audio devices in proximity from each other or by sharing a unique code.
